(19) United States
(12) Patent Application Publication
(10) Pub. No.: US 2024/0406484 A1
(43) Pub. Date: Dec. 5, 2024

(54) INTERACTIVE SERVICES

(71) Applicant: Sky CP Limited, Isleworth, Middlesex (GB)

(72) Inventors: Anthony Davies, Isleworth, Middlesex (GB); Edward Snodgrass, Isleworth, Middlesex (GB); William Howe, Isleworth, Middlesex (GB)

(73) Assignee: Sky CP Limited, Isleworth, Middlesex (GB)

(21) Appl. No.: 18/698,657

(22) PCT Filed: Oct. 3, 2022
(86) PCT No.: PCT/GB2022/052495

§ 371 Date: Apr. 4, 2024

(30) Foreign Application Priority Data
Oct. 4, 2021 (GB) 2114154.4

(51) Int. Cl. H04N 21/422; H04N 21/45; H04N 21/466

(52) U.S. Cl. CPC H04N 21/4221; H04N 21/4532; H04N 21/4662

(57) ABSTRACT

A media receiving device receives media programmes with associated interactive services, a selected one of which can be triggered by a user pressing a selected one of a plurality of interactive buttons. The media receiving device is provided with a remote control having fewer than said plurality of interactive buttons, and preferably only one such interactive button. The media receiving device maps the interactive button pressed on the remote control to a selected virtual button, based for example on contextual information available to the device.

### FIELD OF THE INVENTION

The present invention relates to interactive services for media receivers.

### BACKGROUND OF THE INVENTION

Conventional digital TV services include interactive functionality, triggered by a user action such as pressing a ‘colour button’ on a remote control. Colour buttons typically comprise red, green, yellow and blue coloured buttons which are commonly provided on remote controls in order to trigger interactive functions provided within TV programmes. The user, when watching a particular programme, may be prompted by the programme content to press a colour button to obtain a particular interactive service e.g. press the red button to see additional content associated with the current programme, or press the green button during a promotional clip to set a reminder or a recording for a programme associated with the promotional clip.

However, including four colour buttons in a remote control can be confusing for the user and can add to the size and complexity of the remote control. On the other hand, omitting the colour buttons would give reduced functionality, with the user unable to trigger interactive services.

### STATEMENTS OF THE INVENTION

According to one aspect of the invention, there is provided a media receiver for receiving media programmes with associated interactive services, a selected one of which can be activated by a user pressing a selected one of a plurality of interactive buttons. The media receiver is provided with a remote control having fewer than said plurality of interactive buttons, and preferably only one such interactive button. The media receiver maps or interprets the interactive button pressed on the remote control to activate a selected one of the plurality of interactive services.

By performing the mapping at the media receiver, the mapping may be based on contextual information that is available to the receiver but may not be available to the remote control. The mapping may be based on the context of a currently received digital programme, for example on the channel, content and/or status of the currently received digital programme. Alternatively or additionally, the mapping may be based on past usage of the media receiver, such as user behaviour patterns.

The mapping may be onto a selected one of a plurality of virtual buttons, such that an input is provided to the interactive services function corresponding to the selected virtual button. In this way, the interactive service functionality itself does not need to be modified.

Advantageously, embodiments of the invention may allow the number of interactive keys or buttons on the remote to be reduced, while allowing access to most or all of the available interactive services.

Other aspects of the invention include a method of operation of the media receiver and remote control, and/or a computer program arranged to perform the method of operation.

### BRIEF DESCRIPTION OF THE DRAWINGS

There now follows, by way of example only, a detailed description of embodiments of the present invention in which:

FIG. 1 is a schematic diagram of a media receiver and a remote control;

FIG. 2 shows an example button configuration of the remote control;

FIG. 3 is a schematic diagram showing mapping of an interactive button of the remote control to a selected interactive service; and

FIG. 4 is a schematic diagram of components of the media receiver.

### DETAILED DESCRIPTION OF THE EMBODIMENTS

### Television Display Apparatus

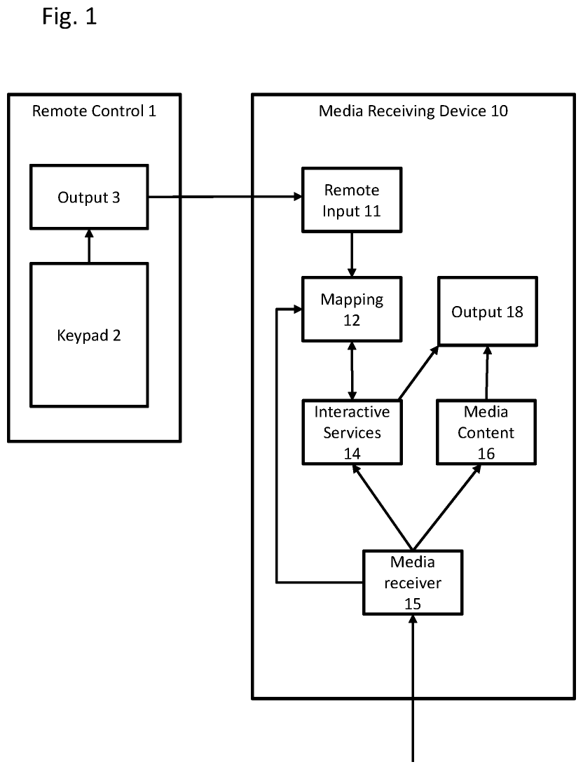

FIG. 1 shows schematically a media receiving device 10, which may for example comprise a set-top box or a smart TV arranged to receive media content 16, such audio and/or video content, over one or more transport networks such as broadcast, video-on-demand (VOD) and/or IP streaming networks, by means of a media receiver 15. The media content 16 may be provided to an output 18, such as a display screen and/or speakers in the case of a Smart TV, or an output interface such as an HDMI interface in the case of a set-top box.

The media receiving device 10 is controlled by a user by means of a remote control 1 including a keypad 2 and an output 3 for transmitting remote control signals, indicating one or more key or button presses on the keypad 2, to a remote control input 11 of the media receiving device 10. The signals may be wireless signals, such as infra-red (IR) or radio frequency (RF) signals. The RF signals may comply with a standard such as Bluetooth® or BlueTooth® LE.

The media receiver 15 provides interactive services 14, which may be defined by metadata and/or program code received by the media receiver 15, associated with the received media content 16. The metadata may comprise XSI (extended service information) data compliant with DVB (digital video broadcasting) standards. For example, the metadata may be indicated by a PAT (program association table) which indicates interactive services associated with a programme stream.

Available interactive services may be defined by triggers included in the metadata associated with a programme stream, the trigger defining the message to be overlaid, the button to which the trigger is responsive, and the action to be executed when that button is pressed. The action may include executing a computer programme application, and the metadata may include data to be passed to that application, for example in JSON (JavaScript Object Notation) format. The application may already be resident or running on the device 10, or may be downloaded in response to the device 10 receiving the trigger. The computer programme application, when executed, provides the interactive service, examples of which are described below.

An available interactive service 14 may be activated by the user pressing a corresponding button or key on the remote control 1. In a conventional remote control, there may be four ‘colour buttons’, identified as red, green, blue and yellow, for activating a corresponding available interactive service. Pressing an interactive service button or key causes a corresponding interactive service selection signal to be sent from the remote control 1 to the device 10, which responds by activating a corresponding available interactive service.

For example, the media content 16 may include a message to the viewer to ‘press the red button’ to view additional or alternative content. In one example, the media content 16 comprises a sports programme such as a Wimbledon tennis match. The media receiver 15 may receive metadata defining how the receiving device 10 responds to the user pressing the red button on their remote control: for example, display a menu from which the user may select an IP streaming service to receive streamed content relating to a selected other tennis match. The user may be prompted to press the red button by a message overlaid on the programme, for example as defined by the metadata, or included in the programme.

Some interactive services may be available throughout the programme or channel with which they are associated. Other interactive services 14 may be available only for a short time, for example synchronised with a short period within a programme, or with a short programme. One such example is an interactive advertisement or promotion, with a message to the viewer to press the green button for further information or functionality relating to the advertisement or promotion. For example, the promotion may relate to a forthcoming programme or series, and pressing the green button may set a reminder or recording of the programme or series to which the promotion relates. In another example, pressing the green button may cause the receiving device 10 to receive and output additional content relating to an advertisement, or may cause the receiving device 10 to display a menu allowing ordering of a product or service to which the advertisement relates.

In another example, pressing the green button during a broadcast programme may switch the receiver 15 to an IP streaming version of the programme, allowing the user to start viewing from the beginning of the programme.

There may be at least two different types of interactive service available at the same time, which require different colour buttons to activate them; hence the need for at least two colour buttons on a conventional remote control. Typically, four colour buttons are provided for backwards compatibility; some of these buttons may activate functions other than interactive services.

However the requirement to include at least two and preferably four colour buttons on the remote control adds to the already large number of buttons required e.g. numeric buttons and buttons for menu navigation, pause/play, fast forward/rewind, volume control etc. This can make the remote control cluttered and difficult to use, and may also place a limit on the minimum size of the remote control.

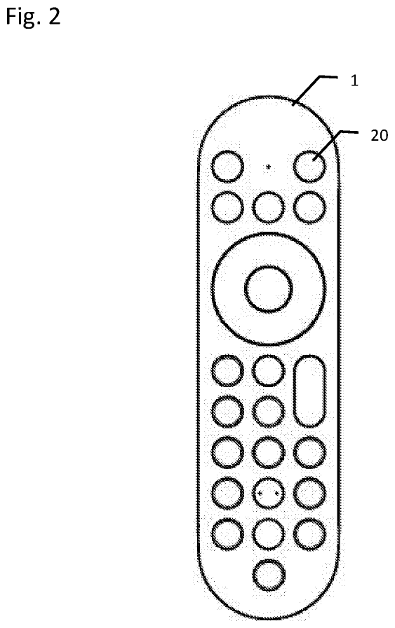

In an embodiment of the invention, the remote control 1 has a single interactive services (IS) button 20, as shown in FIG. 2, that is used to activate an available interactive service 14, and the media receiving device 10 includes a mapping function 12 that maps a press of the single IS button 20 to a selected one of a plurality of colour buttons, based on contextual information available to the device 10. The contextual information may comprise a service identifier (e.g. a channel number) identifying the service currently received by the media receiver 15. For example, for BBC channels the single IS button 20 may be always mapped to a red button.

Alternatively or additionally, the contextual information may include timing information, such as time elapsed since the start of the current programme. For channels where pressing the green button allows the user to view the programme from the beginning using an IP streaming service, the single IS button 20 may be mapped to the green button for a predetermined time from the beginning of the programme, such as 10 minutes, and mapped to the red button for the rest of the programme; the red button may activate an interactive service 14 to view additional or alternative content, which is more likely to be of interest later on in a programme, even if the green button interactive service is still available.

Alternatively or additionally, the contextual information may include interactive services metadata indicating the currently available interactive service 14 and the associated colour button required to activate it. If there is only one currently available interactive service corresponding to only one colour button, the single IS button 20 may be mapped to that button. This mapping may be changed as the available interactive service 14 and its associated colour button changes.

Alternatively or additionally, the contextual information may include information relating to user preference or behaviour, such as past activations of interactive services 14 by users of the device 10.

The mapping of the single IS button 20 to the corresponding colour button may be performed by a machine learning algorithm having the contextual information as input. The algorithm may be trained using contextual information for different users of a plurality of devices 10, and information on subsequent user behaviour. For example, if the user intended to activate an interactive service 14 corresponding to the red button but the mapping function 12 mapped onto a green button, the user may rapidly cancel the interactive service activated by the mapped green button.

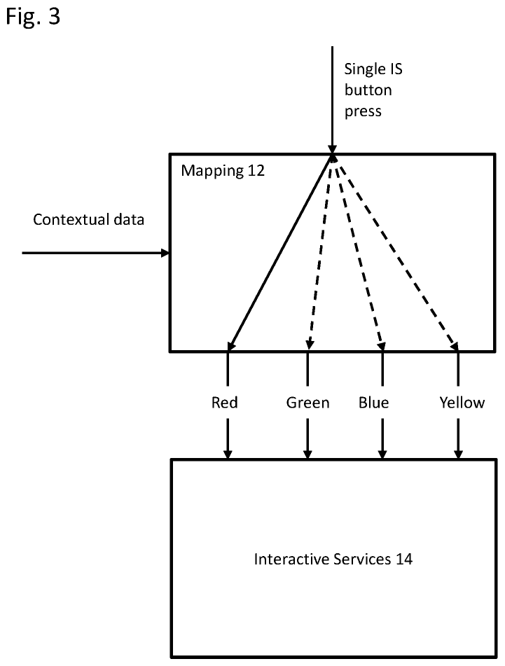

As illustrated in FIG. 3, the mapping function 12 may map an interactive service selection signal (e.g. a button press code) received by the remote control input 11, in response to pressing the single IS button 20, to a virtual user input (e.g. virtual button press code) corresponding to the colour button (e.g. red, green, blue or yellow) selected by the mapping function 12. The virtual button press code is input to the trigger of an available interactive service 14. In this way, the mapping function 12 may be implemented without modification of the interactive services function 14.

In alternative embodiments of the invention, there may be a first plurality of IS buttons 20 for generating corresponding different interactive service selection signals, and a second plurality of different interactive services 14, where the first plurality is fewer than the second plurality e.g. two IS buttons 20 that are mapped onto activation of three or more different types of interactive service 14.

Instead of pressing an IS button or key 20, the user may perform a predetermined gesture or action with the remote control 1, such as a swipe gesture on a touch-sensitive surface or a movement of the remote control 1 that is detected by an accelerometer. The gesture or action may be converted to a corresponding interactive service selection signal, either within the remote control 1 or the media receiving device 10.

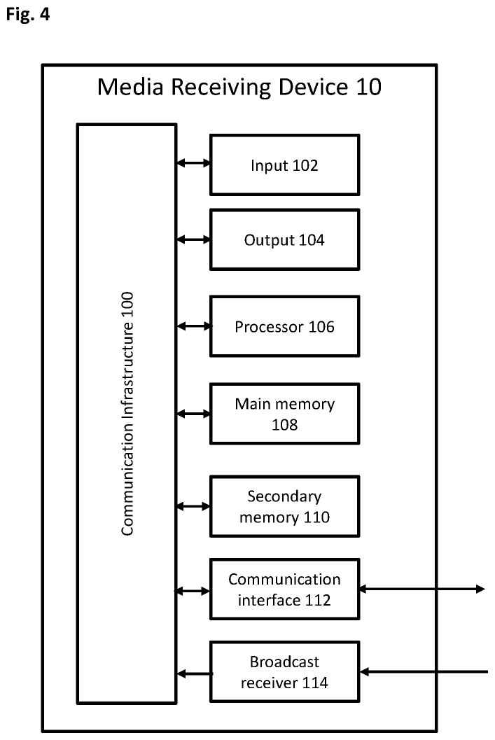

FIG. 4 shows the functional components of the media receiving device 10, including a communication infrastructure 100 such as a local bus or network through which the other components are interconnected; these components may include:
one or more processors 106, which may be a special purpose or a general-purpose digital signal processor arranged to execute one or more computer programs, such as the mapping function 12 and/or computer program applications associated with the interactive services 14;
one or more input devices 102 (e.g. keys, touch panel or screen, voice input) by which the user interacts with the device 10;
one or more output devices 104 (e.g. display screen, speaker, haptic feedback device) for outputting selected content to the user of the device 10;
main memory 108 (e.g. solid state memory) to store computer program code for execution by the processor, cached media content and/or data, such as the interactive service metadata;
secondary memory 110 (e.g. removable solid state drive) for storage of media content, computer programmes and/or data;
communication interface 112 (e.g. WiFi or other wireless interface) for communication with other devices or entities, for example for downloading computer programme applications or streaming media channels; and
broadcast receiver 114, for receiving broadcast channels.

The device 10 may, instead of or in addition to having a separate broadcast receiver 114, receive streaming content via the communication interface 112.

### Alternative Embodiments

The embodiments described above are illustrative of rather than limiting to the present invention. Alternative embodiments apparent on reading the above description may nevertheless fall within the scope of the invention.

### Alternative Statements of Invention

Alternative statements of invention are recited below as numbered clauses.

1. A media receiver for receiving and outputting media content and providing a plurality of different interactive services associated with the output media content in response to respective different user inputs, the media receiver including a mapping function for mapping a received user input to a selected one of the different user inputs, such that a corresponding available one of the interactive services is activated.
2. The media receiver of clause 1, wherein the received user input is provided by a remote control in response to a predetermined user action.
3. The media receiver of clause 2, wherein the predetermined user action comprises pressing a key or button on the remote control.
4. The media receiver of any preceding clause, wherein the mapping function maps the received user input to a selected one of a plurality of virtual user inputs corresponding to a selected one of the different user inputs.
5. The media receiver of any preceding clause, wherein the mapping is based on contextual information available at the media receiver.
6. The media receiver of any preceding clause, wherein the mapping is based on a media service currently output by the media receiver.
7. The media receiver of any preceding clause, wherein the mapping is based on timing information.
8. The media receiver of any preceding clause, wherein the mapping is based on user preference or behaviour.
9. The media receiver of any preceding clause, wherein the mapping function comprises a machine learning algorithm.
10. A method of operating the media receiver of any preceding clause, the method including mapping the received user input to the selected one of the different user inputs, and activating the corresponding available one of the interactive services.
11. A computer program comprising program code arranged to perform the method of clause 10.

1. A media receiver for receiving and outputting media content and providing a plurality of different interactive services associated with the output media content, the media receiver being controllable by a user by means of a remote control arranged to transmit to the media receiver one or more interactive service selection signals, each of which is transmitted in response to a corresponding predetermined user action, wherein the number of different interactive service selection signals is fewer than the number of different interactive services, the media receiver including a mapping function for mapping a received interactive service selection signal to a selected one of the different interactive services, such that a corresponding available one of the interactive services is activated.

2. The media receiver of claim 1, wherein the predetermined user action comprises pressing a key or button on the remote control.

3. The media receiver of claim 2, wherein the remote control includes one or more interactive services selection buttons or keys corresponding to one or more respective interactive service selection signals.

4. The media receiver of claim 3, wherein the remote control includes a single interactive services selection button or key and the mapping function maps the corresponding received interactive service selection signal to a selected one of a plurality of different interactive services.

5. The media receiver of claim 1, wherein the mapping function maps a received interactive service selection signal to a selected one of a plurality of virtual user inputs corresponding to a selected one of the different interactive services.

6. The media receiver of claim 1, wherein the mapping is based on contextual information available at the media receiver.

7. The media receiver of claim 1, wherein the mapping is based on a media service currently output by the media receiver.

8. The media receiver of claim 1, where the mapping is based on the availability of the interactive services.

9. The media receiver of claim 1, wherein the mapping is based on timing information.

10. The media receiver of claim 1, wherein the mapping is based on user reference or behaviour.

11. The media receiver of claim 1, wherein the mapping function comprises a machine learning algorithm.

12. A system comprising the media receiver and the remote control of claim 1.

13. A method of operating the media receiver of claim 1, the method including mapping the received interactive service selection signal to the selected one of the interactive services, and activating the corresponding available one of the interactive services.

14. A computer program comprising program code arranged to perform the method of claim 13.

15. The media receiver of claim 5, wherein the media receiver is arranged to receive a program stream and the mapping function is arranged to map the received interactive service selection signal to a selected one of a plurality of virtual user inputs corresponding to a selected one of the different interactive services defined by metadata in the program stream.
